(19) United States
(12) Patent Application Publication
(10) Pub. No.: US 2026/0089597 A1
(43) Pub. Date: Mar. 26, 2026

(54) MACHINE LEARNING-ENABLED MOBILITY FOR WIRELESS COMMUNICATIONS

(71) Applicant: QUALCOMM Incorporated, San Diego, CA (US)

(72) Inventors: Punyaslok PURKAYASTHA, San Diego, CA (US); Ozcan OZTURK, San Diego, CA (US)

(21) Appl. No.: 18/895,193

(22) Filed: Sep. 24, 2024

(51) Int. Cl. H04W 36/30; H04W 36/00; H04W 36/08

(52) U.S. Cl. CPC H04W 36/30; H04W 36/0058; H04W 36/08

(57) ABSTRACT

Methods, systems, and devices for wireless communications are described. A user equipment (UE) may receive first reference signaling from a first cell. The UE may perform a handover procedure to the first cell in accordance with a set of one or more values of a set of one or more parameters associated with the handover procedure, wherein the set of one or more values is selected based at least in part on a machine learning model and the received first reference signaling.

### FIELD OF TECHNOLOGY

The following relates to wireless communications, including machine learning-enabled mobility for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first reference signaling from a first cell and performing a handover procedure to the first cell in accordance with a set of one or more values of a set of one or more parameters associated with the handover procedure, where the set of one or more values is selected based on a machine learning model and the received first reference signaling.

A UE for wireless communications is described. The UE may include one or more memories storing processor executable code, and one or more processors coupled with the one or more memories. The one or more processors may individually or collectively be operable to execute the code to cause the UE to receive first reference signaling from a first cell and perform a handover procedure to the first cell in accordance with a set of one or more values of a set of one or more parameters associated with the handover procedure, where the set of one or more values is selected based on a machine learning model and the received first reference signaling.

Another UE for wireless communications is described. The UE may include means for receiving first reference signaling from a first cell and means for performing a handover procedure to the first cell in accordance with a set of one or more values of a set of one or more parameters associated with the handover procedure, where the set of one or more values is selected based on a machine learning model and the received first reference signaling.

A non-transitory computer-readable medium storing code for wireless communications is described. The code may include instructions executable by one or more processors to receive first reference signaling from a first cell and perform a handover procedure to the first cell in accordance with a set of one or more values of a set of one or more parameters associated with the handover procedure, where the set of one or more values is selected based on a machine learning model and the received first reference signaling.

Some examples of the method, UE, and non-transitory computer-readable medium described herein may further include operations, features, means, or instructions for receiving second reference signaling from a second cell including a serving cell of the UE, where the handover procedure to the first cell may be performed based on the received second reference signaling.

Some examples of the method, UE, and non-transitory computer-readable medium described herein may further include operations, features, means, or instructions for determining a first threshold value based on a first measurement of the received first reference signaling, where the first measurement includes at least one of a first actual measurement or a first predicted measurement, determining a second threshold value based on a second measurement of the received second reference signaling, where the second measurement includes at least one of a second actual measurement or a second predicted measurement, determining a third threshold value based on a difference between the first measurement and the second measurement, where the handover procedure may be performed based on the first threshold value, the second threshold value, or the third threshold value, or any combination thereof.

Some examples of the method, UE, and non-transitory computer-readable medium described herein may further include operations, features, means, or instructions for receiving a configuration that indicates a set of multiple candidate values for each of one or more parameters of the set of one or more parameters associated with the handover procedure, where the set of one or more values may be selected from the set of multiple candidate values.

Some examples of the method, UE, and non-transitory computer-readable medium described herein may further include operations, features, means, or instructions for transmitting a request message to modify at least one value or a range of values of at least one parameter of the set of one or more parameters associated with the handover procedure and receiving a response message that indicates an acknowledgement of the modified at least one value or the modified range of values of the at least one parameter in response to the transmitted request message.

In some examples of the method, UE, and non-transitory computer-readable medium described herein, the handover procedure may be performed based on a set of one or more conditions, and where the set of one or more conditions include a radio link failure (RLF), a threshold duration for the handover procedure, a link quality associated with the first cell, or any combination thereof.

In some examples of the method, UE, and non-transitory computer-readable medium described herein, an output of the machine learning model includes a predicted set of one or more values of the set of one or more parameters associated with the handover procedure and the method, apparatuses, and non-transitory computer-readable medium may include further operations, features, means, or instructions for determining whether the predicted set of one or more values satisfies a set of one or more conditions, where the handover procedure may be performed based on the set of one or more conditions being satisfied by the predicted set of one or more values.

In some examples of the method, UE, and non-transitory computer-readable medium described herein, at least one condition of the set of one or more conditions includes a throughput during a duration associated with the handover procedure.

In some examples of the method, UE, and non-transitory computer-readable medium described herein, the set of one or more parameters includes a value associated with a time window, and where the time window corresponds to a first time instance associated with at least one condition of a set of one or more conditions being satisfied and a second time instance associated with a beginning of the handover procedure.

Some examples of the method, UE, and non-transitory computer-readable medium described herein may further include operations, features, means, or instructions for transmitting an indication of the set of one or more values of the set of one or more parameters associated with the handover procedure.

Some examples of the method, UE, and non-transitory computer-readable medium described herein may further include operations, features, means, or instructions for determining the set of one or more values of the set of one or more parameters associated with the handover procedure based on the machine learning model and transmitting a report indicating at least one of the set of one or more values of the set of one or more parameters associated with the handover procedure, or one or more metrics associated with the determined set of one or more values.

Some examples of the method, UE, and non-transitory computer-readable medium described herein may further include operations, features, means, or instructions for transmitting a report indicating at least one of a first measurement of the received first reference signaling from the first cell or a first measurement prediction, or a second measurement of received second reference signaling from a second cell including a serving cell of the UE or a second measurement prediction and where the handover procedure may be performed based on whether a handover command may be received within a threshold duration after the transmitted report.

Some examples of the method, UE, and non-transitory computer-readable medium described herein may further include operations, features, means, or instructions for estimating a delay time between the transmitted report and reception of the handover command, where the set of one or more values may be based on the estimated delay time.

In some examples of the method, UE, and non-transitory computer-readable medium described herein, the handover procedure includes a cell change procedure, and where the cell change procedure includes a conditional primary special cell (PSCell) addition procedure, a measurement report-based PSCell addition procedure, a subsequent PSCell conditional addition procedure, a conditional PSCell change procedure, a measurement report-based PSCell change procedure, or a subsequent PSCell conditional change procedure.

A method for wireless communications by a network entity is described. The method may include transmitting first reference signaling from a first cell and performing a handover procedure to the first cell in accordance with a set of one or more values of a set of one or more parameters associated with the handover procedure, where the set of one or more values is selected based on a machine learning model and the received first reference signaling.

A network entity for wireless communications is described. The network entity may include one or more memories storing processor executable code, and one or more processors coupled with the one or more memories. The one or more processors may individually or collectively be operable to execute the code to cause the network entity to transmit first reference signaling from a first cell and perform a handover procedure to the first cell in accordance with a set of one or more values of a set of one or more parameters associated with the handover procedure, where the set of one or more values is selected based on a machine learning model and the received first reference signaling.

Another network entity for wireless communications is described. The network entity may include means for transmitting first reference signaling from a first cell and means for performing a handover procedure to the first cell in accordance with a set of one or more values of a set of one or more parameters associated with the handover procedure, where the set of one or more values is selected based on a machine learning model and the received first reference signaling.

A non-transitory computer-readable medium storing code for wireless communications is described. The code may include instructions executable by one or more processors to transmit first reference signaling from a first cell and perform a handover procedure to the first cell in accordance with a set of one or more values of a set of one or more parameters associated with the handover procedure, where the set of one or more values is selected based on a machine learning model and the received first reference signaling.

Some examples of the method, network entity, and non-transitory computer-readable medium described herein may further include operations, features, means, or instructions for transmitting a configuration that indicates a set of multiple candidate values for each of one or more parameters of the set of one or more parameters associated with the handover procedure, where the set of one or more values may be selected from the set of multiple candidate values.

Some examples of the method, network entity, and non-transitory computer-readable medium described herein may further include operations, features, means, or instructions for receiving a request message to modify at least one value or a range of values of at least one parameter of the set of one or more parameters associated with the handover procedure and transmitting a response message that indicates an acknowledgement of the modified at least one value or the modified range of values of the at least one parameter in response to the received request message.

In some examples of the method, network entity, and non-transitory computer-readable medium described herein, the handover procedure may be performed based on a set of one or more conditions, and where the set of one or more conditions include a RLF, a threshold duration for the handover procedure, a link quality associated with the first cell, or any combination thereof.

In some examples of the method, network entity, and non-transitory computer-readable medium described herein, an output of the machine learning model includes a predicted set of one or more values of the set of one or more parameters associated with the handover procedure and the method, apparatuses, and non-transitory computer-readable medium may include further operations, features, means, or instructions for determining whether the predicted set of one or more values satisfies a set of one or more conditions, where the handover procedure may be performed based on the set of one or more conditions being satisfied by the predicted set of one or more values.

In some examples of the method, network entity, and non-transitory computer-readable medium described herein, at least one condition of the set of one or more conditions includes a throughput during a duration associated with the handover procedure.

In some examples of the method, network entity, and non-transitory computer-readable medium described herein, the set of one or more parameters includes a value associated with a time window, and where the time window corresponds to a first time instance associated with at least one condition of a set of one or more conditions being satisfied and a second time instance associated with a beginning of the handover procedure.

Some examples of the method, network entity, and non-transitory computer-readable medium described herein may further include operations, features, means, or instructions for receiving an indication of the set of one or more values of the set of one or more parameters associated with the handover procedure.

Some examples of the method, network entity, and non-transitory computer-readable medium described herein may further include operations, features, means, or instructions for receiving a report indicating at least one of the set of one or more values of the set of one or more parameters associated with the handover procedure, or one or more metrics associated with the determined set of one or more values, where the set of one or more values of the set of one or more parameters associated with the handover procedure may be determined based on the machine learning model.

Some examples of the method, network entity, and non-transitory computer-readable medium described herein may further include operations, features, means, or instructions for receiving a report indicating at least one of a first measurement of the first reference signaling from the first cell or a first measurement prediction, or a second measurement of second reference signaling from a second cell including a serving cell of the UE or a second measurement prediction and where the handover procedure may be performed based on whether a handover command may be transmitted within a threshold duration after the received report.

In some examples of the method, network entity, and non-transitory computer-readable medium described herein, the handover procedure includes a cell change procedure, and where the cell change procedure includes a conditional PSCell addition procedure, a measurement report-based PSCell addition procedure, a subsequent PSCell conditional addition procedure, a conditional PSCell change procedure, a measurement report-based PSCell change procedure, or a subsequent PSCell conditional change procedure.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support machine learning-enabled mobility for wireless communications in accordance with one or more examples as disclosed herein.

FIGS. 3 through 6 show example of handover schemes that support machine learning-enabled mobility for wireless communications in accordance with one or more examples as disclosed herein.

FIG. 7 shows an example of a process flow that supports machine learning-enabled mobility for wireless communications in accordance with one or more examples as disclosed herein.

FIGS. 8 and 9 show block diagrams of devices that support machine learning-enabled mobility for wireless communications in accordance with one or more examples as disclosed herein.

FIG. 10 shows a block diagram of a communications manager that supports machine learning-enabled mobility for wireless communications in accordance with one or more examples as disclosed herein.

FIG. 11 shows a diagram of a system including a device that supports machine learning-enabled mobility for wireless communications in accordance with one or more examples as disclosed herein.

FIGS. 12 and 13 show block diagrams of devices that support machine learning-enabled mobility for wireless communications in accordance with one or more examples as disclosed herein.

FIG. 14 shows a block diagram of a communications manager that supports machine learning-enabled mobility for wireless communications in accordance with one or more examples as disclosed herein.

FIG. 15 shows a diagram of a system including a device that supports machine learning-enabled mobility for wireless communications in accordance with one or more examples as disclosed herein.

FIGS. 16 and 17 show flowcharts illustrating methods that support machine learning-enabled mobility for wireless communications in accordance with one or more examples as disclosed herein.

### DETAILED DESCRIPTION

A device may support (e.g., perform) mobility in which the device may switch (e.g., changes) operation from one network entity (e.g., a cell covered by the network entity) to another network entity (e.g., another cell covered by the other network entity). In some cases of mobility, radio link failure (RLF) may occur during a handover procedure (e.g., operation, action, task). In these cases, a connection between the device and the network entity may be lost or significantly degraded during the handover (e.g., transition, switch) to the other network entity. Additionally, or alternatively, failure in the handover procedure may occur due to an expiry of a timer (e.g., a T304 timer) or after accessing the other network entity (e.g., the other cell). Expiry of the timer may indicate a failure in an execution phase of the handover procedure, potentially leading to an unsuccessful handover. Additionally, or alternatively, a failure in the handover procedure may occur after the device has accessed the other network entity (e.g., the other cell), which could be due to a variety of factors, such as poor signal quality or network congestion. Additionally, or alternatively, extended handover interruption times may also be experienced. For example, in cases in which the handover procedure takes an extended period, the device may experience a temporary loss of service. Any of these cases may result in degraded user experience, increased latency, reduced throughput, reduced communications quality, or other effects.

Techniques for machine leaning determination of handover parameter values may be employed. For example, a device may receive reference signaling (e.g., from a serving cell, a candidate cell, or both) and may perform one or more measurements or predict one or more measurements associated with the reference signaling. The device may perform a machine learning analysis of the measurements (e.g., actual or predicted) to determine one or more values for one or more handover parameters such that a predicted handover procedure based on the handover parameters satisfies one or more conditions for the handover procedure, such as avoidance of an RLF, performance of the handover procedure within a threshold duration (e.g., to reduce interruptions from the handover procedure), or a signal strength of the candidate cell that satisfies a signal strength threshold. Such techniques may be applied to conditional handover procedures, measurement report-based handover procedures, conditional primary secondary cell (PSCell) (or primary special cell (PSCell)) addition (CPA) or PSCell change (CPC), or other handover procedures. In at least these ways, RLF occurrences may be reduced, communications quality, throughput, resource utilization, flexibility, and reliability may be increased while reducing overhead, latency, and delays due to handover procedures.

Aspects of the disclosure are initially described in the context of wireless communications systems. Aspects of the disclosure are then described with reference to a wireless communications system, handover schemes, and a process flow. Aspects of the disclosure are further illustrated by and described with reference to apparatus diagrams, system diagrams, and flowcharts that relate to machine learning-enabled mobility for wireless communications.

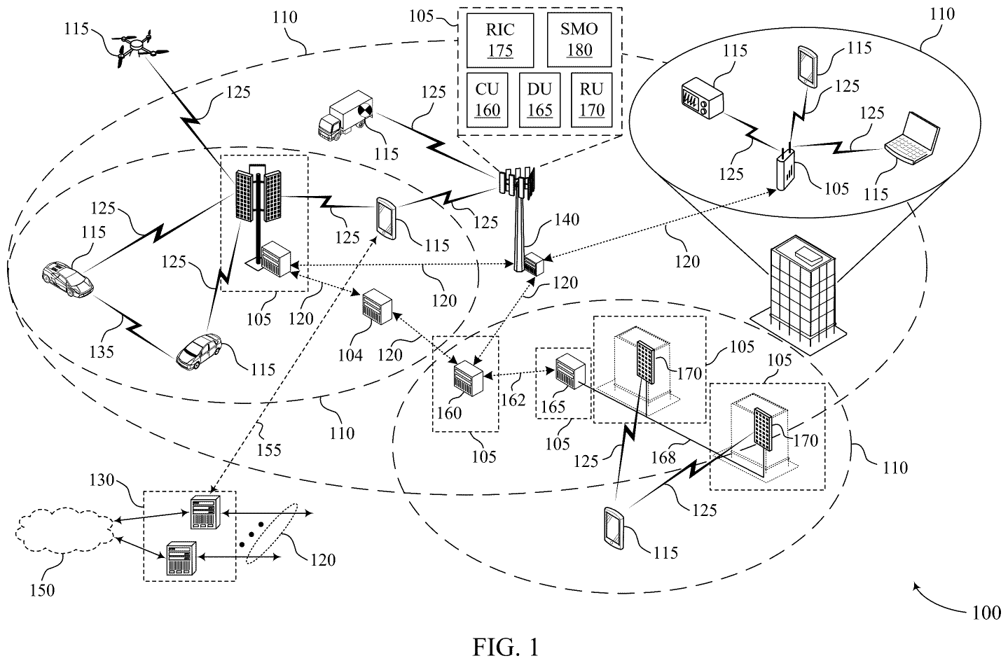

FIG. 1 shows an example of a wireless communications system 100 that supports machine learning-enabled mobility for wireless communications in accordance with one or more examples as disclosed herein. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may employ machine learning techniques to determine one or more handover parameter values. For example, a UE may receive reference signaling (e.g., from a serving cell, a candidate cell, or both) and may perform one or more measurements or predict one or more measurements associated with the reference signaling (e.g., using a machine learning analysis). Based on the measurements and machine learning analysis, the UE may determine one or more parameters or values thereof to use for the handover procedure. In some examples, such parameters or values thereof may be determined based on satisfaction of one or more conditions, including avoidance of an RLF, performance of the handover procedure within a threshold amount of time (e.g., to reduce interruptions from the handover procedure), or a signal strength of the candidate cell that satisfies a signal strength threshold.

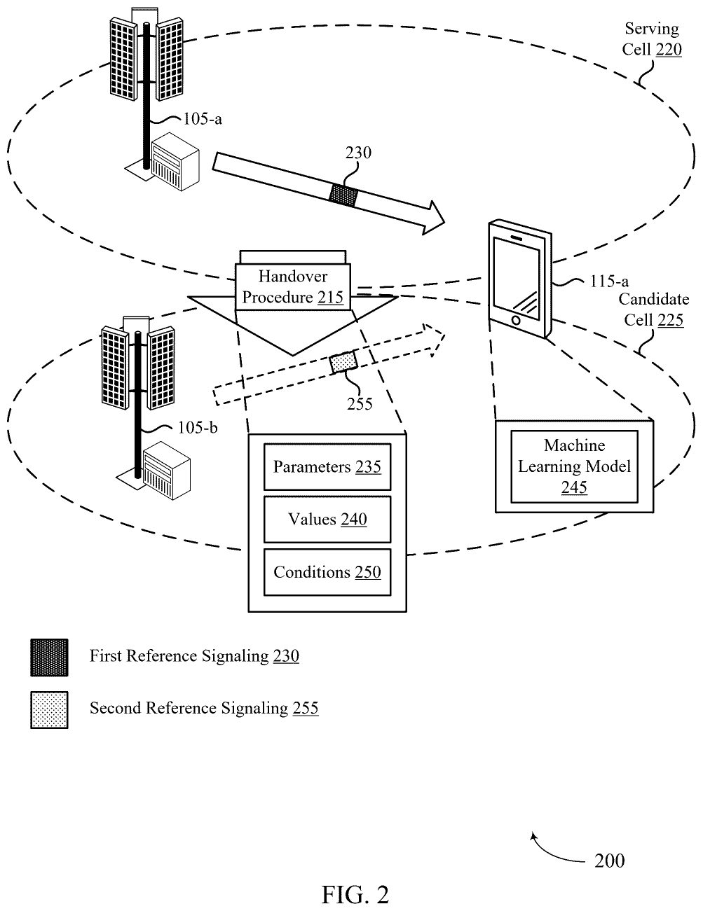

FIG. 2 shows an example of a wireless communications system 200 that supports machine learning-enabled mobility for wireless communications in accordance with one or more examples as disclosed herein. In some examples, the wireless communications system 200 may implement or be implemented by aspects of the wireless communications system 100 as described herein with reference to FIG. 1. For example, the wireless communications system 200 may include a network entity 105-a, a network entity 105-b, and a UE 115-a which may be an example of network entities 105 and UEs 115 as described herein with reference to FIG. 1.

In the wireless communications system 200, the UE 115-a may perform a handover procedure 215 to establish communications with a different cell or network entity. For example, the UE 115-a may perform the handover procedure 215 to discontinue communications with the network entity 105-a covering (e.g., associated with) a serving cell 220 and may establish communications with the network entity 105-b covering (e.g., associated with) a candidate cell 225. In some examples, a configuration of the handover procedure 215 may involve use of event thresholds, time to trigger parameters, hysteresis operations, parameters, or values, or any combination thereof. Some handover procedures (e.g., including conditional handover (CHO) procedures) may involve one or more events. For example, an event, such as an A3 event may occur when a candidate cell signal level (e.g., a reference signal received power (RSRP), a reference signal received quality (RSRQ), signal to interference and noise ratio (SINR), or other measurement metric) becomes greater than a sum of a source or serving cell signal level (e.g., RSRP, RSRQ, OR SINR) and a difference threshold (e.g., threshA3). Another event, such as an A5 event may occur when a candidate cell signal level becomes greater than a candidate cell threshold (e.g., threshA5_C) and a source or serving cell signaling level becomes less than a source or serving cell threshold (e.g., threshA5_S). In some examples, for triggering CHO execution, one or multiple events, such as A3 and A5 events may have to occur (e.g., the conditions for the A3 and A5 events need to be satisfied).

In the example of FIG. 2, the handover procedure 215 may be performed in relation to one or more performance objectives. One example performance objective may include a reduction of one or more communication failures, such as an RLF for the serving cell 220 and/or a handover failure (HOF). In some examples, a HOF may result due to an expiration of a T304 timer or a failure after accessing a target cell (also referred to as a candidate cell 225). Another example performance objective may include or a reduction in a handover interruption time in which there is no data exchange with one or more of the network entity 105-a or the network entity 105-b.

To achieve such performance objectives, the UE 115-a may receive a first reference signaling 230 from the network entity 105-a, the second control signaling 255 from the network entity 105-b, or both. The UE 115-a may determine one or more values 240 that are to be applied to handover parameters 235 as part of the handover procedure 215 (e.g., based on one or more measurements of the first reference signaling 230, the second control signaling 255, one or more other parameters, or any combination thereof). In some examples, the UE 115-a may determine such values 240 based at least in part on applying a machine learning model 245. For example, the UE 115-a may receive the first reference signaling 230 from the network entity 105-a and may receive additional reference signaling from the network entity 105-b or from another source. The UE 115-a may measure the first reference signaling 230, the additional reference signaling, or both and may provide one or more aspects of the measurement to the machine learning model 245, which may generate (e.g., obtain, determine, produce, calculate, select) one or more values 240 that are to be used for parameters 235 and during the handover procedure 215. In some examples, the UE 115-a may provide information associated with one or more conditions 250 to the machine learning model 245, which may influence (e.g., impact) the output of the machine learning model 245 (e.g., the one or more values 240 for the handover procedure parameters 235). For example, the machine learning model 245 may be instructed that the values 240 are to be selected to satisfy one or more of the conditions 250 and that, if the one or more conditions 250 are not satisfied, that the one or more values 240 are to be adjusted (e.g., modified, updated) until the values 240 satisfy the conditions 250.

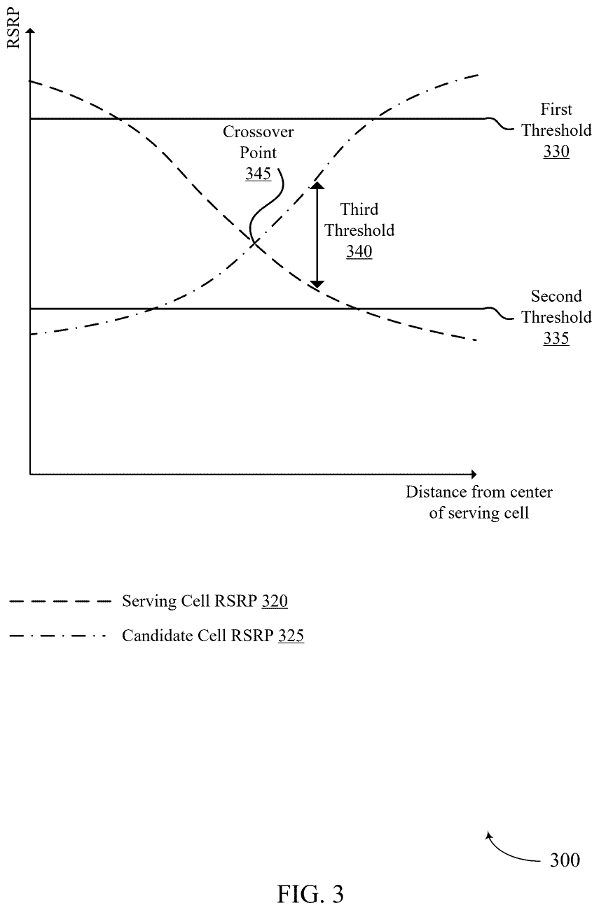

FIG. 3 shows an example of a handover scheme 300 that supports machine learning-enabled mobility for wireless communications in accordance with one or more examples as disclosed herein. In the following description of the handover scheme 300, operations may be performed in a different order than the example order described, or the operations may be performed in different orders or at different times. Some operations may also be omitted from the handover scheme 300, and other operations may be added to the handover scheme 300. Though reference is made to RSRPs (e.g., the serving cell RSRP 320 and the candidate cell RSRP 325), is to be understood that any reference herein to an RSRP may refer to an RSRP, RSRQ, SINR, one or more other signal quality metrics or characteristics, or any combination thereof.

The handover scheme 300 may be associated with a conditional handover procedure between a serving cell (e.g., the serving cell 220 as described with reference to FIG. 2) and a candidate cell (e.g., the candidate cell 225 as described with reference to FIG. 2) and may involve one or more conditions for a handover procedure to be performed. In one example, a first threshold 330 (e.g., threshA5_C, corresponding to the candidate cell) and a second threshold 335 (e.g., threshA5_S corresponding to the serving cell) may both be set approximately to an RSRP value, RSRQ value, SINR value, or any combination thereof, corresponding to a crossover point 345. In this example, a third threshold 340 (e.g., threshA3) may be set to a value of 0 (e.g., threshA3=0). In such a scenario, when a UE (e.g., the UE 115-a as described with reference to FIG. 2) moves sufficiently (e.g., a distance away from the center of the serving cell) such that a serving cell RSRP 320 and a candidate cell RSRP 325 reach (e.g., attains, touches, achieves) the crossover point 345, it may be desirable that the handover procedure be performed quickly, as the serving cell RSRP 320 may continue to be reduced, degrading communications quality, and possibly risking a serving cell RLF. Additionally, or alternatively, it may be desirable to wait until the candidate cell RSRP 325 improves so that the UE (e.g., the UE 115-a as described with reference to FIG. 2) succeeds in accessing the candidate cell, and the time to complete access to the candidate cell (e.g., by performing a random access channel (RACH) procedure) is small.

Thus, in some examples, the UE (e.g., the UE 115-a as described with reference to FIG. 2) may determine (e.g., during a training phase, an inference phase, or both), a value for the first threshold 330, the second threshold 335, and the third threshold 340, such that one or more conditions are met. Such conditions may include avoidance of an RLF (e.g., associated with the serving cell, the candidate cell, or both), successful access of the candidate cell, such as within a threshold amount of time, which time may be determined by the UE. For example, if the candidate cell RSRP 325 indicates sufficient signal strength, the UE may perform a 2-step RACH.

In some examples, the UE may select one or more values for handover parameters from network configured ranges (e.g., suggested values, a set of discrete possible values, a range of values, other forms of values, or any combination thereof) for the parameters. Such parameters may be received from a network entity (e.g., the network entity 105-a and/or the network entity 105-b as described with reference to FIG. 2). In some examples, the UE may use measured or predicted serving cell RSRPs 320, candidate cell RSRPs 325, or both to determine the one or more values for handover parameters. For example, the UE may provide to a machine learning model (e.g., the machine learning model 245 as described with reference to FIG. 2) information about the serving cell RSRP 320, the candidate cell RSRP 325, or both, and instruct the machine learning model to predict (e.g., estimate, forecast) future RSRPs (e.g., of the serving cell, the candidate cell, or both), communication events (e.g., RLF), timings for communication events (e.g., time to perform a RACH procedure to connect to the candidate cell), satisfaction or dissatisfaction of one or more conditions, or any combination thereof, to produce one or more recommended values for handover parameters (e.g., which may include thresholds, as described herein, such as the first threshold 330, the second threshold 335, and the third threshold 340).

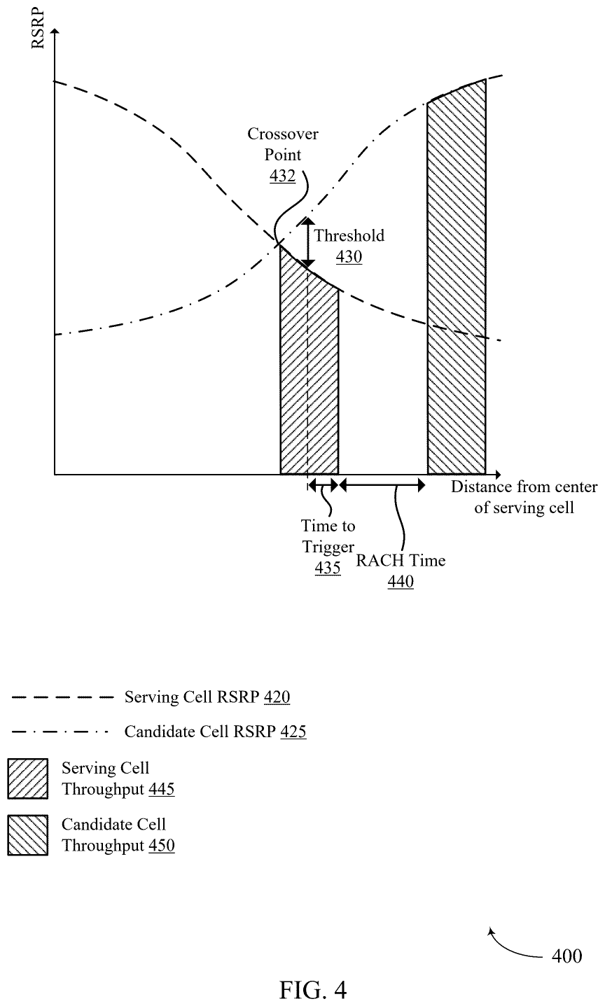

FIG. 4 shows an example of a handover scheme 400 that supports machine learning-enabled mobility for wireless communications in accordance with one or more examples as disclosed herein. In the following description of the handover scheme 400, operations may be performed in a different order than the example order described, or the operations may be performed in different orders or at different times. Some operations may also be omitted from the handover scheme 400, and other operations may be added to the handover scheme 400. Though reference is made to RSRPs (e.g., the serving cell RSRP 420 and the candidate cell RSRP 425), is to be understood that any reference herein to an RSRP may refer to an RSRP, RSRQ, SINR, one or more other signal quality metrics or characteristics, or any combination thereof. Similarly, though reference is made to throughput (e.g., the serving cell throughput 445 and the candidate cell throughput 450), is to be understood that any reference herein to a throughput may refer to a throughput one or more other communication metrics or characteristics, or any combination thereof.

A UE (e.g., the UE 115-a as described with reference to FIG. 2) may adjust thresholds (e.g., a threshold 430, one or more other thresholds described herein, including a first threshold 330, a second threshold 335, and a third threshold 340, or any combination thereof) by small amounts (e.g., incrementally by threshold amounts) and may determine (e.g., using a machine learning model, such as the machine learning model 245 as described with reference to FIG. 2) whether handover performance improves, which may be indicated by one or more outputs of the machine learning model (e.g., which may be generated based on one or more inputs, including a serving cell RSRP 420, a candidate cell RSRP 425, one or more other inputs, or any combination thereof). Such a desired output may include one or more conditions that are satisfied (e.g., one or more of any of the conditions described herein), theoretical throughputs obtained from source and candidate cells (e.g., such as a serving cell throughput 445 after the crossover point 432, a candidate cell throughput 450 after the crossover point 432, or any combination thereof), one or more other outputs, or any combination thereof. In some examples, the UE (e.g., the UE 115-a as described with reference to FIG. 2) may perform an iterative process of adjusting a value and querying the machine learning model to generate updated outputs until a desired output is reached.

In some examples, a time to trigger 435 may be one parameter that may be considered (e.g., alongside one or more other parameters) by the machine learning model to determine parameter values. Additionally, or alternatively, the time to trigger 435 may be one of the parameters or values thereof that are determined in association with the machine learning model. For example, the UE (e.g., the UE 115-a as described with reference to FIG. 2) may jointly determine a value for the event threshold parameters (e.g., one or more of the thresholds described herein) and the time to trigger 435 parameter. In some examples, it may be desirable for the time to trigger 435 to be set to smaller values for a high-speed UE or in association with denser deployments (e.g., mmWave deployments).

In some examples, in response to deriving the handover parameter values (e.g., through the use of the machine learning model, or as otherwise discussed herein), the UE (e.g., the UE 115-a as described with reference to FIG. 2) may report one or more of the determined values to the network along with the associated handover conditions, indicators, or other information. Such conditions, indicators, or information may include a handover interruption time (e.g., a RACH time 440 that defines an amount of time, such as a predicted duration, to complete an access procedure, such as a RACH procedure), a handover rate, RLF failures, user plane performance (e.g., throughput or other measures, such as the serving cell throughput 445, the candidate cell throughput 450, one or more other measures, or any combination thereof).

In some examples, the UE (e.g., the UE 115-a as described with reference to FIG. 2) may perform one or more measurements to determine the handover conditions, indicators, or information. In some examples, a network entity (e.g., the network entity 105-a and/or the network entity 105-b as described with reference to FIG. 2) may configure one or more different ranges for the event parameters for different candidate cells for conditional handover. Additionally, or alternatively, in some examples, the UE may determine different settings for the event parameters for different candidate cells.

In some examples, the UE (e.g., the UE 115-a as described with reference to FIG. 2) may determine that the network configured ranges (e.g., suggested values, sets of possible discrete values, or ranges of values) are insufficient to satisfy one or more handover conditions, indicators, or information. In such a case, the UE (e.g., the UE 115-a as described with reference to FIG. 2) may transmit a request to the network entity (e.g., the network entity 105-a and/or the network entity 105-b as described with reference to FIG. 2) to modify (e.g., update, adjust) the ranges and may provide a suggested list or range of values to the network entity. In some examples, the network entity may reconfigure the UE with modified ranges in response to the UE request.

In some examples, the UE (e.g., the UE 115-a as described with reference to FIG. 2) may transmit a measurement report and wait for an amount of time determined by the UE. If, after the amount of time has passed and the UE does not receive a handover command from the network entity (e.g., the network entity 105-a and/or the network entity 105-b as described with reference to FIG. 2), the UE may perform a conditional handover to a candidate cell selected by the UE.

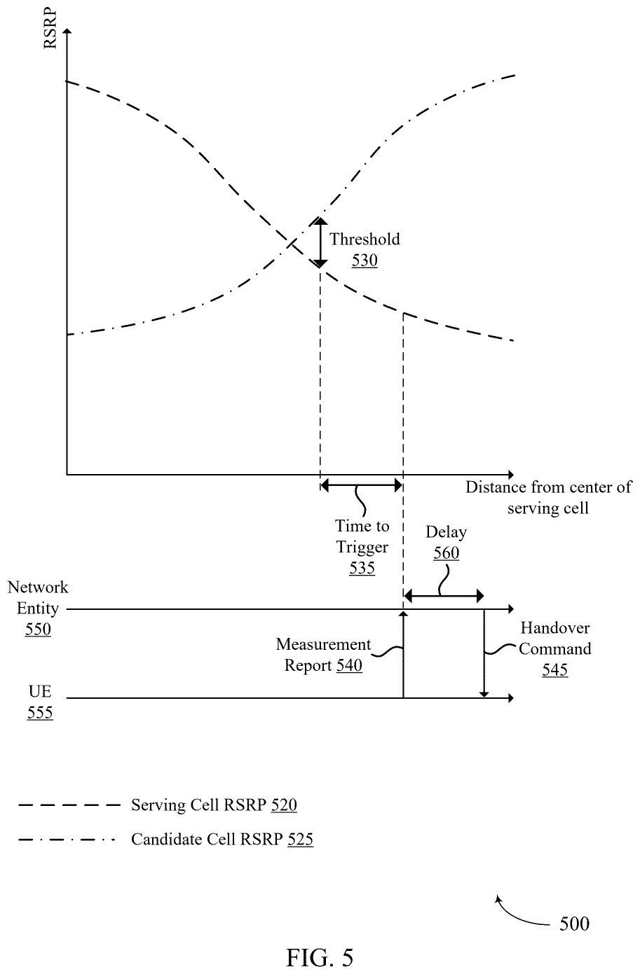

FIG. 5 shows an example of a handover scheme 500 that supports machine learning-enabled mobility for wireless communications in accordance with one or more examples as disclosed herein. The handover scheme 500 may include a network entity 550 and a UE 555, which may be examples of network entities and UEs as described herein. In the following description of the handover scheme 500, the operations between the network entity 550 and the UE 555 may be performed in a different order than the example order described or shown, or the operations performed by the network entity 550 and the UE 555 may be performed in different orders or at different times. Some operations may also be omitted from the handover scheme 500, and other operations may be added to the handover scheme 500. Though reference is made to RSRPs (e.g., the serving cell RSRP 520 and the candidate cell RSRP 525), is to be understood that any reference herein to an RSRP may refer to an RSRP, RSRQ, SINR, one or more other signal quality metrics or characteristics, or any combination thereof.

The UE 555 may perform a non-conditional handover (e.g., in some examples, referred to as a legacy handover) that may be based on a serving cell RSRP 520, a candidate cell RSRP 525, one or more other elements as described herein, or any combination thereof. In such a non-conditional handover, the UE 555 may transmit a measurement report 540 (e.g., to a network entity 550) and may wait to receive a handover command 545 (e.g., in RRC reconfiguration signaling). In response to receiving the measurement report 540, the network entity 550 may initiate one or more handover operation preparations, at the completion of which a handover command may be generated.

In some cases, the UE 555 may employ the use of a machine learning model, iterative processes, and other operations as described herein to determine handover parameter values (e.g., the threshold 530, one or more other thresholds described herein, the time to trigger 535, one or more other parameters described herein, or any combination thereof) for conditional handover operations. In some examples, to determine the handover parameter values, the UE 555 may learn (e.g., estimate, such as through the use of the machine learning model) a delay 560 between a time at which the UE 555 transmits the measurement report 540 and a time at which the UE 555 receives the handover command 545 in response to the measurement report 540. In some examples, the network entity 550 may assist the UE 555 in this regard by providing an estimate of the handover command preparation time, the delay 560, or both.

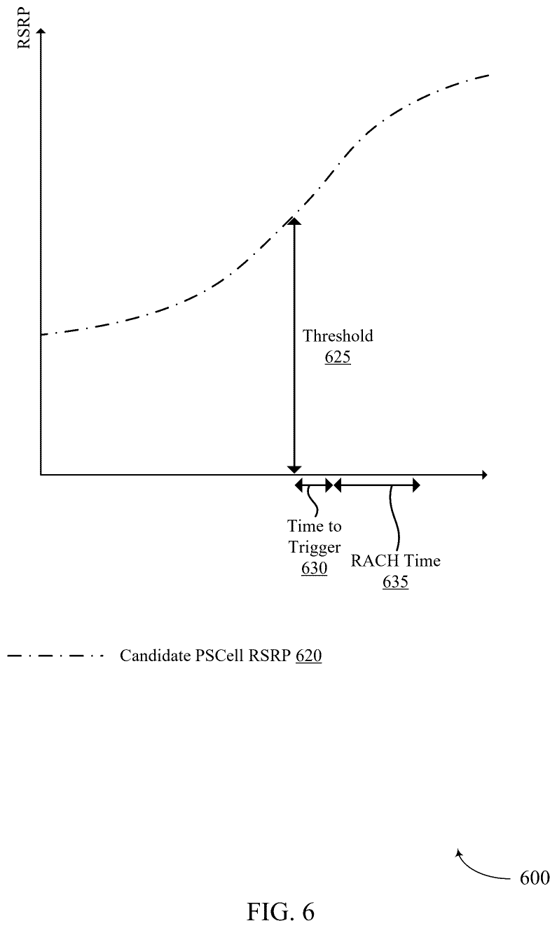

FIG. 6 shows an example of a handover scheme 600 that supports machine learning-enabled mobility for wireless communications in accordance with one or more examples as disclosed herein. In the following description of the handover scheme 600, operations may be performed in a different order than the example order described, or the operations may be performed in different orders or at different times. Some operations may also be omitted from the handover scheme 600, and other operations may be added to the handover scheme 600. Though reference is made to RSRPs (e.g., the candidate PSCell RSRP 620), is to be understood that any reference herein to an RSRP may refer to an RSRP, RSRQ, SINR, one or more other signal quality metrics or characteristics, or any combination thereof.

A UE (e.g., the UE 115-a as described with reference to FIG. 2) may adapt (e.g., adjust, change, modify) operations, techniques, and information described herein in association with condition handover operations, non-conditional handover operations (e.g., legacy handover operations), or both, conditional primary secondary cell (PSCell) addition (CPA) operations, PSCell change (CPC) operations, or both. For example, in some cases involving CPC operations (e.g., secondary node (SN) initiated intra-SN or inter-SN CPC), it may be desirable to perform a PSCell change to move to a PSCell with better coverage (e.g., as in other cases involving mobility or handover procedures). In such cases, A3 and A5 events (e.g., a first threshold 330, a second threshold 335, a third threshold 340, one or more other thresholds, or any combination thereof as described herein with reference to FIG. 3) may be configured for use by the UE. As such, the same techniques described herein (e.g., in relation to conditional handover operations and non-conditional handover operations) may be applied equally to CPC operations, where the serving cell and the candidate cell are serving and candidate PSCells.

In other cases (e.g., CPA and master node (MN) initiated inter-SN CPC), it may be desirable to perform PSCell addition or change for load balancing purposes (e.g., adding or changing to a PSCell that can better handle an offloaded traffic load). In such cases, a threshold 625 may be employed as one threshold to be considered in operations or techniques for PSCell change to which the techniques for conditional handover operations and non-conditional handover operations described herein may be applied. In some examples, the threshold 625 may also be referred to as an A4 or B1 threshold. In some cases, if a candidate PSCell RSRP 620 meets or exceeds a threshold 625, then the PSCell addition or change operation may be performed.

For example, the UE (e.g., the UE 115-a as described with reference to FIG. 2) may determine a value for the threshold 625 (e.g., a threshA4 or threshB1), such that the UE succeeds in accessing the candidate PSCell, and in response to completing access, the signal level (e.g., the candidate PSCell RSRP 620) is sufficiently high so that the candidate PSCell can handle offloaded traffic from the MN link. Additionally, or alternatively, the UE may determine a value for the threshold 625 (e.g., a threshA4 or threshB1), such that the UE can access the candidate PSCell within an amount of time (e.g., a RACH time 635, which may be measured relative to or after the time to trigger 630) determined by the UE.

In some examples, the techniques and operations described herein may apply to PSCell change operations (e.g., “legacy” or non-conditional PSCell change operations). In some examples, the techniques and operations described herein (e.g., those described in relation to conditional handover procedures, non-conditional or legacy handover procedures, conditional CPA/CPC operations, non-conditional CPA/CPC operations, one or more other operations, or any combination thereof) may apply to Subsequent CPA/CPC operations as well.

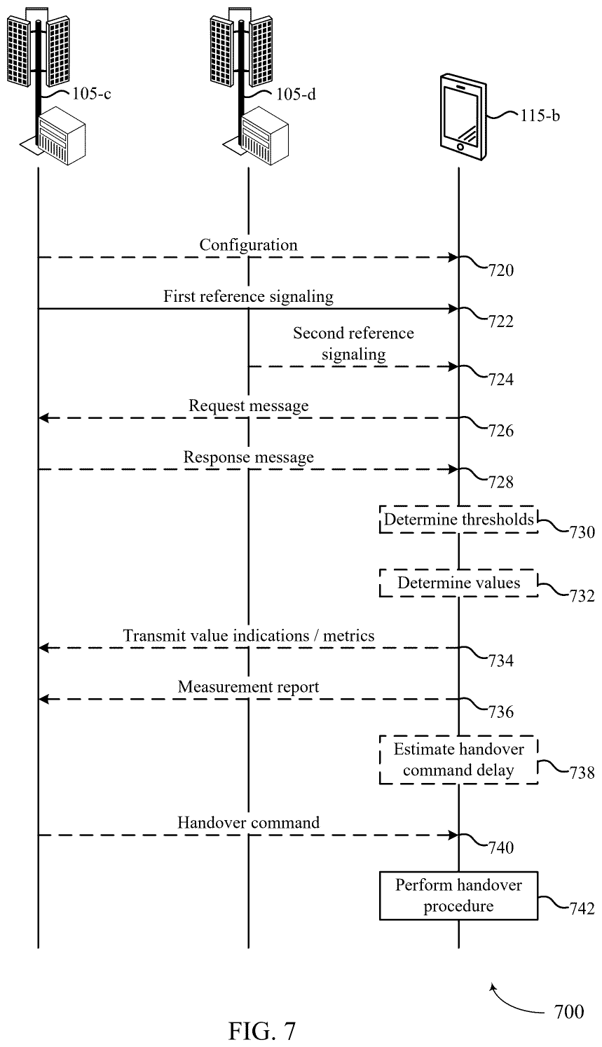

FIG. 7 shows an example of a process flow 700 that supports machine learning-enabled mobility for wireless communications in accordance with one or more examples as disclosed herein. The process flow 700 may implement various aspects of the present disclosure described herein. The elements described in the process flow 700 (e.g., a network entity 105-c, a network entity 105-d, a UE 115-b) may be examples of similarly named elements described herein.

In the following description of the process flow 700, the operations between the various entities or elements may be performed in different orders or at different times. Some operations may also be left out of the process flow 700, or other operations may be added. Although the various entities or elements are shown performing the operations of the process flow 700, some aspects of some operations may also be performed by other entities or elements of the process flow 700 or by entities or elements that are not depicted in the process flow, or any combination thereof.

At 720, the UE 115-b may receive a configuration that indicates a plurality of candidate values for each of one or more parameters of the set of one or more parameters associated with the handover procedure.

At 722, the UE 115-b may receive first reference signaling from a first cell. For example, the network entity 105-c associated with the first cell may transmit, and the UE 115-b may receive, the first reference signaling.

At 724, the UE 115-b may receive second reference signaling from a second cell (e.g., a serving cell of the UE 115-b). For example, the network entity 105-d associated with the second cell may transmit, and the UE 115-b may receive the second reference signaling.

At 726, the UE 115-b may transmit a request message to modify at least one value or a range of values of at least one parameter of the set of one or more parameters associated with the handover procedure. For example, the UE 115-b may transmit, and the network entity 105-c may receive, the request message to modify at least one value or a range of values of at least one parameter of the set of one or more parameters associated with the handover procedure.

At 728, the UE 115-b may receive a response message that indicates an acknowledgement of the modified at least one value or the modified range of values of the at least one parameter in response to the transmitted request message. For example, the network entity 105-c may transmit, and the UE 115-b may receive, the response message that indicates an acknowledgement of the modified at least one value or the modified range of values of the at least one parameter.

At 730, the UE 115-b may determine a first threshold value (e.g., the first threshold 330) based on a first measurement of the received first reference signaling and the first measurement may include at least one of a first actual measurement or a first predicted measurement. In some examples, the UE 115-b may determine a second threshold value (e.g., the second threshold 335) based on a second measurement of the received second reference signaling and the second measurement may include at least one of a second actual measurement or a second predicted measurement. In some examples, the UE 115-b may determine a third threshold value (e.g., third threshold 340) based on a difference between the first measurement and the second measurement.

At 732, the UE 115-b may determine the set of one or more values of the set of one or more parameters associated with the handover procedure based on the machine learning model.

At 734, the UE 115-b may transmit an indication of the set of one or more values of the set of one or more parameters associated with the handover procedure. For example, the UE 115-b may transmit, and the network entity 105-c may receive, the indication of the set of one or more values of the set of one or more parameters associated with the handover procedure. Additionally, or alternatively, the UE 115-b may transmit a report indicating at least one of the set of one or more values of the set of one or more parameters associated with the handover procedure, or one or more metrics associated with the determined set of one or more values.

At 736, the UE 115-b may transmit a report indicating at least one of a first measurement of the received first reference signaling from the first cell (e.g., the network entity 105-c) or a first measurement prediction, or a second measurement of received second reference signaling from the second cell (e.g., the network entity 105-d) or a second measurement prediction.

At 738, the UE 115-b may estimate a delay time between the transmitted report and reception of the handover command and the set of one or more values is based on the estimated delay time.

At 740, the UE 115-b may receive a handover command from the network entity 105-c. In some examples, the UE-115-b may not receive a handover command from the network entity 105-c or may receive a delayed handover command from the network entity 105-c.

At 742, the UE 115-b may perform a handover procedure to the first cell (e.g., associated with the network entity 105-d) in accordance with a set of one or more values of a set of one or more parameters associated with the handover procedure and the set of one or more values is selected based on a machine learning model and the received first reference signaling. In some examples, the handover procedure to the first cell is performed based on the received second reference signaling. In some examples, the handover procedure may be performed based on the first threshold value, the second threshold value, or the third threshold value, or any combination thereof. In some examples, the set of one or more values is selected from the plurality of candidate values.

In some examples, the handover procedure is performed based on a set of one or more conditions, and wherein the set of one or more conditions comprise an RLF, a threshold duration for the handover procedure, a link quality associated with the first cell, or any combination thereof.

In some examples, an output of the machine learning model may include a predicted set of one or more values of the set of one or more parameters associated with the handover procedure and the UE 115-b may determine whether the predicted set of one or more values satisfies a set of one or more conditions. The UE 115-b may perform the handover procedure based on the set of one or more conditions being satisfied by the predicted set of one or more values. In some examples, at least one condition of the set of one or more conditions may include a throughput during a duration associated with the handover procedure.

In some examples, the set of one or more parameters may include a value associated with a time window, and wherein the time window corresponds to a first time instance associated with at least one condition of a set of one or more conditions being satisfied and a second time instance associated with a beginning of the handover procedure.

In some examples, the handover procedure is performed based on whether a handover command is received within a threshold duration after the transmitted report.

In some examples, the handover procedure may include a cell change procedure, and wherein the cell change procedure may include a conditional PSCell addition procedure, a measurement report-based PSCell addition procedure, a subsequent PSCell conditional addition procedure, a conditional PSCell change procedure, a measurement report-based PSCell change procedure, or a subsequent PSCell conditional change procedure.

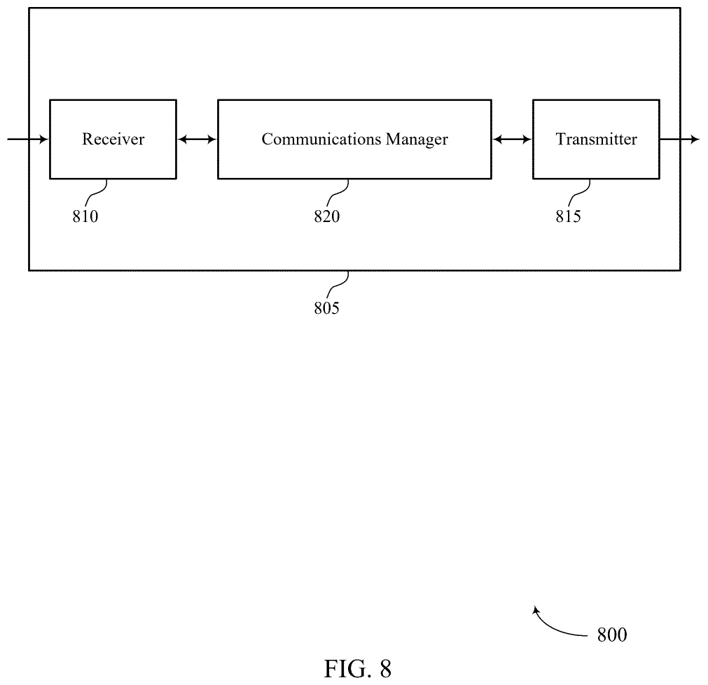

FIG. 8 shows a block diagram 800 of a device 805 that supports machine learning-enabled mobility for wireless communications in accordance with one or more examples as disclosed herein. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to machine learning-enabled mobility for wireless communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to machine learning-enabled mobility for wireless communications). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of machine learning-enabled mobility for wireless communications as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

Additionally, or alternatively, the communications manager 820 may support wireless communications in accordance with examples as disclosed herein. For example, the communications manager 820 is capable of, configured to, or operable to support a means for receiving first reference signaling from a first cell. The communications manager 820 is capable of, configured to, or operable to support a means for performing a handover procedure to the first cell in accordance with a set of one or more values of a set of one or more parameters associated with the handover procedure, where the set of one or more values is selected based on a machine learning model and the received first reference signaling.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, more efficient utilization of communication resources, or any combination thereof.

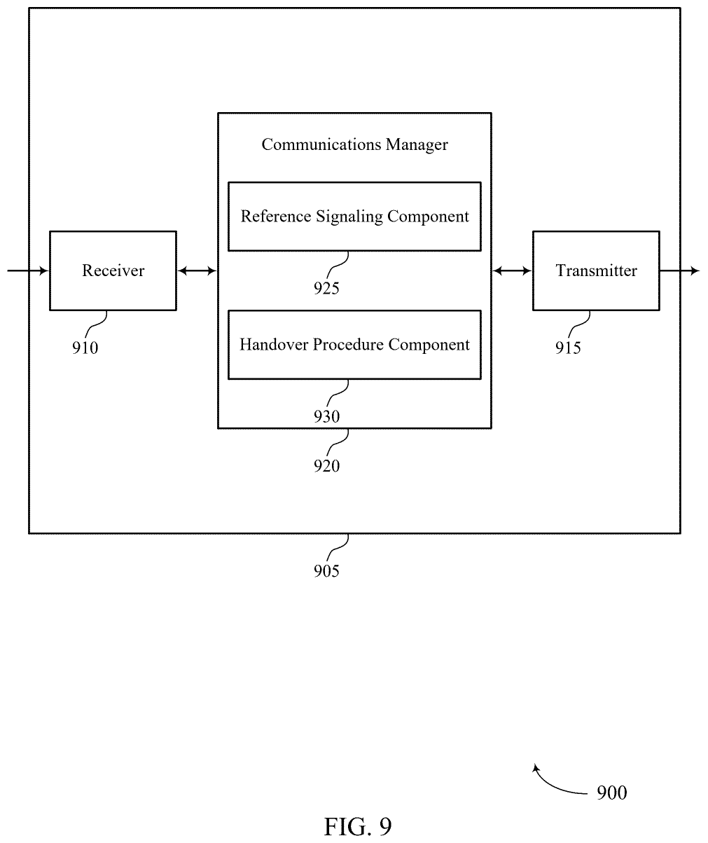

FIG. 9 shows a block diagram 900 of a device 905 that supports machine learning-enabled mobility for wireless communications in accordance with one or more examples as disclosed herein. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to machine learning-enabled mobility for wireless communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to machine learning-enabled mobility for wireless communications). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of machine learning-enabled mobility for wireless communications as described herein. For example, the communications manager 920 may include a reference signaling component 925 a handover procedure component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The reference signaling component 925 is capable of, configured to, or operable to support a means for receiving first reference signaling from a first cell. The handover procedure component 930 is capable of, configured to, or operable to support a means for performing a handover procedure to the first cell in accordance with a set of one or more values of a set of one or more parameters associated with the handover procedure, where the set of one or more values is selected based on a machine learning model and the received first reference signaling.

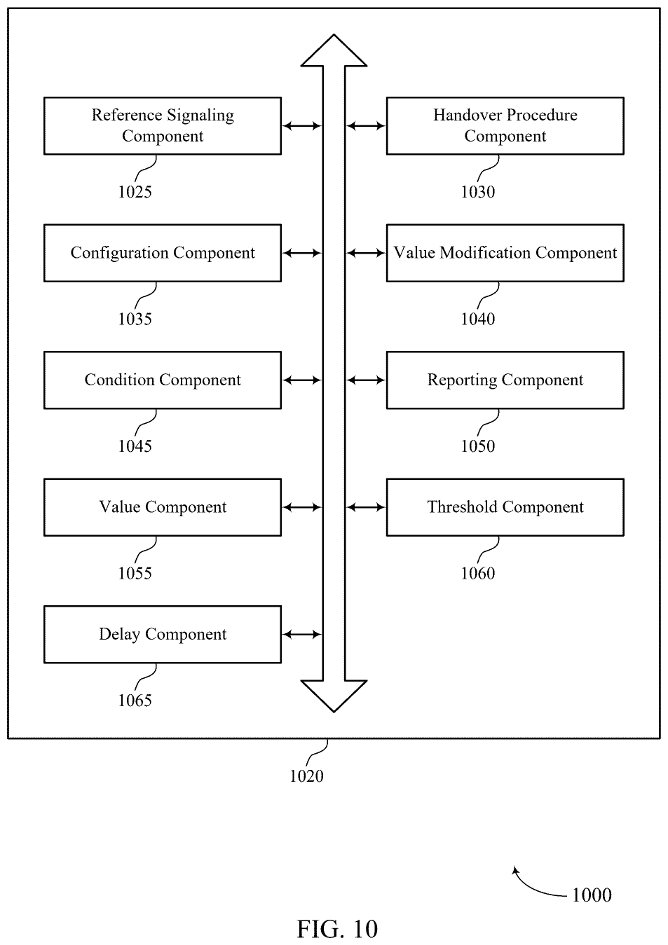

FIG. 10 shows a block diagram 1000 of a communications manager 1020 that supports machine learning-enabled mobility for wireless communications in accordance with one or more examples as disclosed herein. The communications manager 1020 may be an example of aspects of a communications manager 820, a communications manager 920, or both, as described herein. The communications manager 1020, or various components thereof, may be an example of means for performing various aspects of machine learning-enabled mobility for wireless communications as described herein. For example, the communications manager 1020 may include a reference signaling component 1025, a handover procedure component 1030, a configuration component 1035, a value modification component 1040, a condition component 1045, a reporting component 1050, a value component 1055, a threshold component 1060, a delay component 1065, or any combination thereof. Each of these components, or components or subcomponents thereof (e.g., one or more processors, one or more memories), may communicate, directly or indirectly, with one another (e.g., via one or more buses).

Additionally, or alternatively, the communications manager 1020 may support wireless communications in accordance with examples as disclosed herein. The reference signaling component 1025 is capable of, configured to, or operable to support a means for receiving first reference signaling from a first cell. The handover procedure component 1030 is capable of, configured to, or operable to support a means for performing a handover procedure to the first cell in accordance with a set of one or more values of a set of one or more parameters associated with the handover procedure, where the set of one or more values is selected based on a machine learning model and the received first reference signaling.

In some examples, the reference signaling component 1025 is capable of, configured to, or operable to support a means for receiving second reference signaling from a second cell including a serving cell of the UE, where the handover procedure to the first cell is performed based on the received second reference signaling.

In some examples, the threshold component 1060 is capable of, configured to, or operable to support a means for determining a first threshold value based on a first measurement of the received first reference signaling, where the first measurement includes at least one of a first actual measurement or a first predicted measurement. In some examples, the threshold component 1060 is capable of, configured to, or operable to support a means for determining a second threshold value based on a second measurement of the received second reference signaling, where the second measurement includes at least one of a second actual measurement or a second predicted measurement. In some examples, the threshold component 1060 is capable of, configured to, or operable to support a means for determining a third threshold value based on a difference between the first measurement and the second measurement. In some examples, the handover procedure is performed based on the first threshold value, the second threshold value, or the third threshold value, or any combination thereof.

In some examples, the configuration component 1035 is capable of, configured to, or operable to support a means for receiving a configuration that indicates a set of multiple candidate values for each of one or more parameters of the set of one or more parameters associated with the handover procedure, where the set of one or more values is selected from the set of multiple candidate values.

In some examples, the value modification component 1040 is capable of, configured to, or operable to support a means for transmitting a request message to modify at least one value or a range of values of at least one parameter of the set of one or more parameters associated with the handover procedure. In some examples, the value modification component 1040 is capable of, configured to, or operable to support a means for receiving a response message that indicates an acknowledgement of the modified at least one value or the modified range of values of the at least one parameter in response to the transmitted request message.

In some examples, the handover procedure is performed based on a set of one or more conditions, and where the set of one or more conditions include an RLF, a threshold duration for the handover procedure, a link quality associated with the first cell, or any combination thereof.

In some examples, an output of the machine learning model includes a predicted set of one or more values of the set of one or more parameters associated with the handover procedure, and the condition component 1045 is capable of, configured to, or operable to support a means for determining whether the predicted set of one or more values satisfies a set of one or more conditions, where the handover procedure is performed based on the set of one or more conditions being satisfied by the predicted set of one or more values.

In some examples, at least one condition of the set of one or more conditions includes a throughput during a duration associated with the handover procedure.

In some examples, the set of one or more parameters includes a value associated with a time window, and where the time window corresponds to a first time instance associated with at least one condition of a set of one or more conditions being satisfied and a second time instance associated with a beginning of the handover procedure.

In some examples, the reporting component 1050 is capable of, configured to, or operable to support a means for transmitting an indication of the set of one or more values of the set of one or more parameters associated with the handover procedure.

In some examples, the value component 1055 is capable of, configured to, or operable to support a means for determining the set of one or more values of the set of one or more parameters associated with the handover procedure based on the machine learning model. In some examples, the reporting component 1050 is capable of, configured to, or operable to support a means for transmitting a report indicating at least one of the set of one or more values of the set of one or more parameters associated with the handover procedure, or one or more metrics associated with the determined set of one or more values.

In some examples, the reporting component 1050 is capable of, configured to, or operable to support a means for transmitting a report indicating at least one of a first measurement of the received first reference signaling from the first cell or a first measurement prediction, or a second measurement of received second reference signaling from a second cell including a serving cell of the UE or a second measurement prediction. In some examples, the handover procedure component 1030 is capable of, configured to, or operable to support a means for performing the handover procedure based on whether a handover command is received within a threshold duration after the transmitted report.

In some examples, the delay component 1065 is capable of, configured to, or operable to support a means for estimating a delay time between the transmitted report and reception of the handover command, where the set of one or more values is based on the estimated delay time.

In some examples, the handover procedure includes a cell change procedure, and where the cell change procedure includes a conditional PSCell addition procedure, a measurement report-based PSCell addition procedure, a subsequent PSCell conditional addition procedure, a conditional PSCell change procedure, a measurement report-based PSCell change procedure, or a subsequent PSCell conditional change procedure.

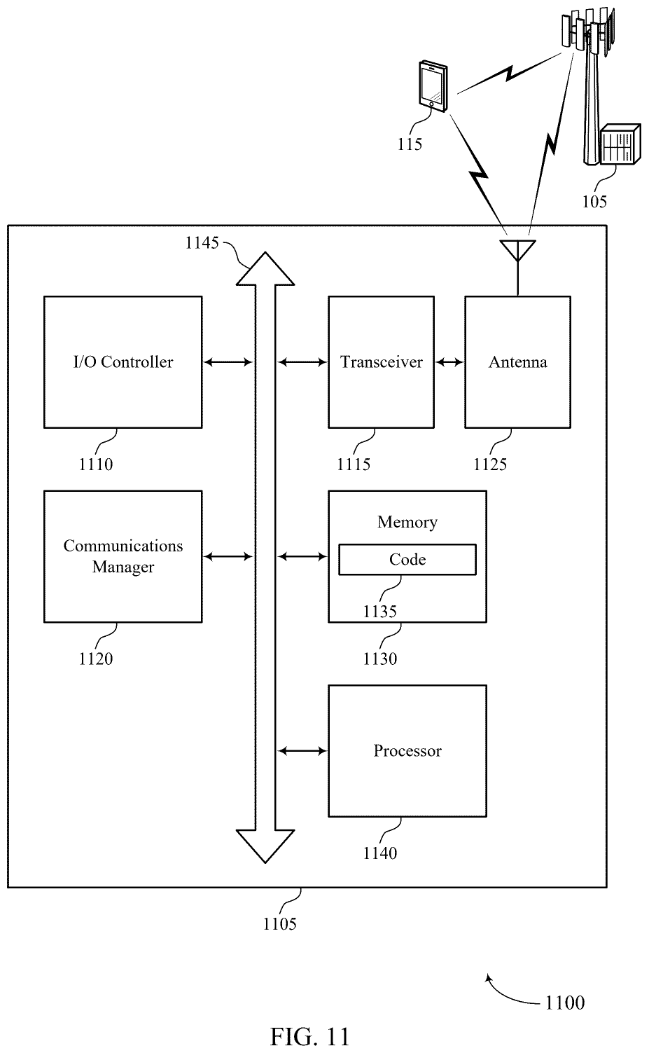

FIG. 11 shows a diagram of a system 1100 including a device 1105 that supports machine learning-enabled mobility for wireless communications in accordance with one or more examples as disclosed herein. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting machine learning-enabled mobility for wireless communications). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

Additionally, or alternatively, the communications manager 1120 may support wireless communications in accordance with examples as disclosed herein. For example, the communications manager 1120 is capable of, configured to, or operable to support a means for receiving first reference signaling from a first cell. The communications manager 1120 is capable of, configured to, or operable to support a means for performing a handover procedure to the first cell in accordance with a set of one or more values of a set of one or more parameters associated with the handover procedure, where the set of one or more values is selected based on a machine learning model and the received first reference signaling.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of machine learning-enabled mobility for wireless communications as described herein, or the at least one processor 1140 and the at least one memory 1130 may be otherwise configured to, individually or collectively, perform or support such operations.

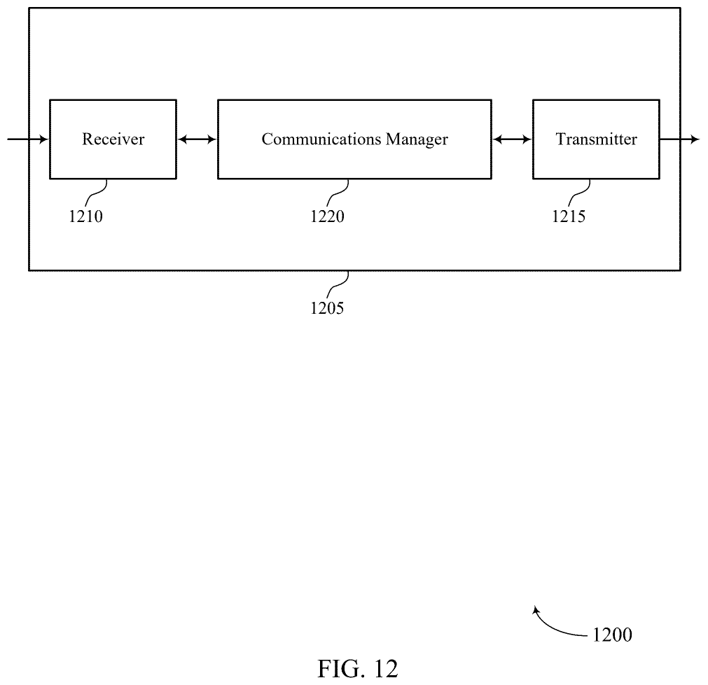

FIG. 12 shows a block diagram 1200 of a device 1205 that supports machine learning-enabled mobility for wireless communications in accordance with one or more examples as disclosed herein. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of machine learning-enabled mobility for wireless communications as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

Additionally, or alternatively, the communications manager 1220 may support wireless communications in accordance with examples as disclosed herein. For example, the communications manager 1220 is capable of, configured to, or operable to support a means for transmitting first reference signaling from a first cell. The communications manager 1220 is capable of, configured to, or operable to support a means for performing a handover procedure to the first cell in accordance with a set of one or more values of a set of one or more parameters associated with the handover procedure, where the set of one or more values is selected based on a machine learning model and the first reference signaling.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing, reduced power consumption, more efficient utilization of communication resources, or any combination thereof.

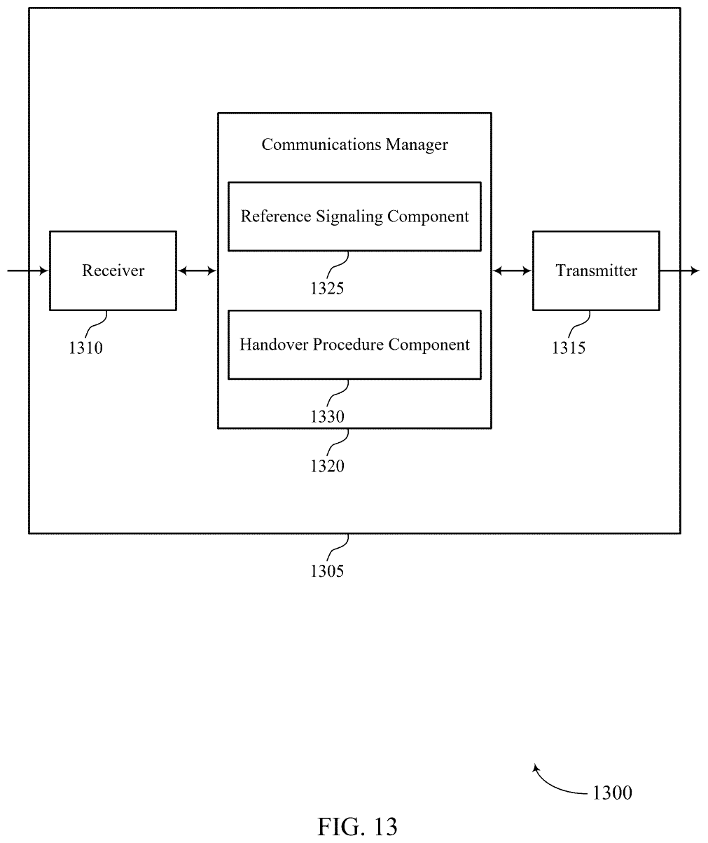

FIG. 13 shows a block diagram 1300 of a device 1305 that supports machine learning-enabled mobility for wireless communications in accordance with one or more examples as disclosed herein. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of machine learning-enabled mobility for wireless communications as described herein. For example, the communications manager 1320 may include a reference signaling component 1325 a handover procedure component 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The reference signaling component 1325 is capable of, configured to, or operable to support a means for transmitting first reference signaling from a first cell. The handover procedure component 1330 is capable of, configured to, or operable to support a means for performing a handover procedure to the first cell in accordance with a set of one or more values of a set of one or more parameters associated with the handover procedure, where the set of one or more values is selected based on a machine learning model and the first reference signaling.

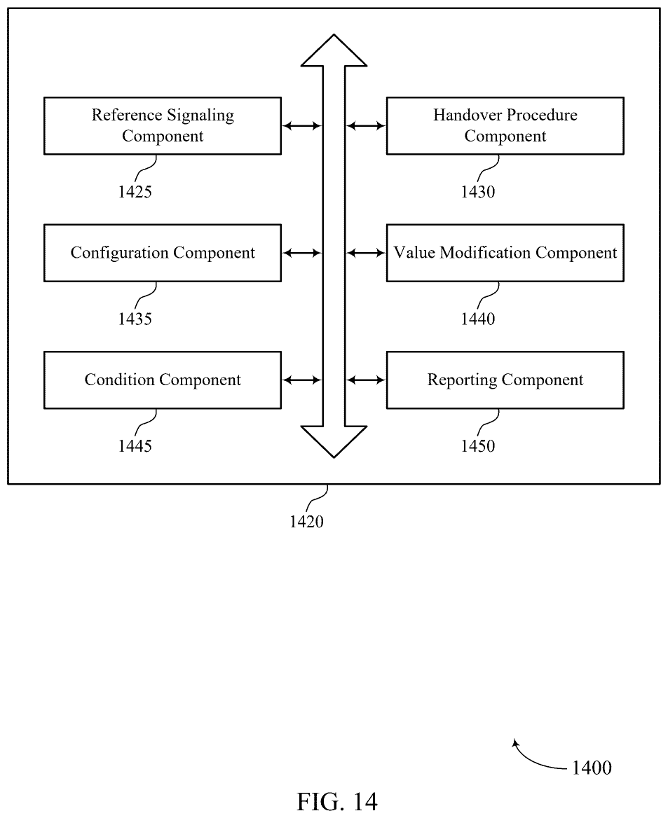

FIG. 14 shows a block diagram 1400 of a communications manager 1420 that supports machine learning-enabled mobility for wireless communications in accordance with one or more examples as disclosed herein. The communications manager 1420 may be an example of aspects of a communications manager 1220, a communications manager 1320, or both, as described herein. The communications manager 1420, or various components thereof, may be an example of means for performing various aspects of machine learning-enabled mobility for wireless communications as described herein. For example, the communications manager 1420 may include a reference signaling component 1425, a handover procedure component 1430, a configuration component 1435, a value modification component 1440, a condition component 1445, a reporting component 1450, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 1420 may support wireless communications in accordance with examples as disclosed herein. The reference signaling component 1425 is capable of, configured to, or operable to support a means for transmitting first reference signaling from a first cell. The handover procedure component 1430 is capable of, configured to, or operable to support a means for performing a handover procedure to the first cell in accordance with a set of one or more values of a set of one or more parameters associated with the handover procedure, where the set of one or more values is selected based on a machine learning model and the first reference signaling.

In some examples, the configuration component 1435 is capable of, configured to, or operable to support a means for transmitting a configuration that indicates a set of multiple candidate values for each of one or more parameters of the set of one or more parameters associated with the handover procedure, where the set of one or more values is selected from the set of multiple candidate values.

In some examples, the value modification component 1440 is capable of, configured to, or operable to support a means for receiving a request message to modify at least one value or a range of values of at least one parameter of the set of one or more parameters associated with the handover procedure. In some examples, the value modification component 1440 is capable of, configured to, or operable to support a means for transmitting a response message that indicates an acknowledgement of the modified at least one value or the modified range of values of the at least one parameter in response to the received request message.

In some examples, the handover procedure is performed based on a set of one or more conditions, and where the set of one or more conditions include an RLF, a threshold duration for the handover procedure, a link quality associated with the first cell, or any combination thereof.

In some examples, an output of the machine learning model includes a predicted set of one or more values of the set of one or more parameters associated with the handover procedure, and the condition component 1445 is capable of, configured to, or operable to support a means for determining whether the predicted set of one or more values satisfies a set of one or more conditions, where the handover procedure is performed based on the set of one or more conditions being satisfied by the predicted set of one or more values.

In some examples, at least one condition of the set of one or more conditions includes a throughput during a duration associated with the handover procedure.

In some examples, the set of one or more parameters includes a value associated with a time window, and where the time window corresponds to a first time instance associated with at least one condition of a set of one or more conditions being satisfied and a second time instance associated with a beginning of the handover procedure.

In some examples, the reporting component 1450 is capable of, configured to, or operable to support a means for receiving an indication of the set of one or more values of the set of one or more parameters associated with the handover procedure.

In some examples, the reporting component 1450 is capable of, configured to, or operable to support a means for receiving a report indicating at least one of the set of one or more values of the set of one or more parameters associated with the handover procedure, or one or more metrics associated with the set of one or more values, where the set of one or more values of the set of one or more parameters associated with the handover procedure is determined based on the machine learning model.

In some examples, the reporting component 1450 is capable of, configured to, or operable to support a means for receiving a report indicating at least one of a first measurement of the first reference signaling from the first cell or a first measurement prediction, or a second measurement of received second reference signaling from a second cell including a serving cell of the UE or a second measurement prediction. In some examples, the handover procedure component 1430 is capable of, configured to, or operable to support a means for performing the handover procedure based on whether a handover command is transmitted within a threshold duration after the received report.

In some examples, the handover procedure includes a cell change procedure, and where the cell change procedure includes a conditional PSCell addition procedure, a measurement report-based PSCell addition procedure, a subsequent PSCell conditional addition procedure, a conditional PSCell change procedure, a measurement report-based PSCell change procedure, or a subsequent PSCell conditional change procedure.

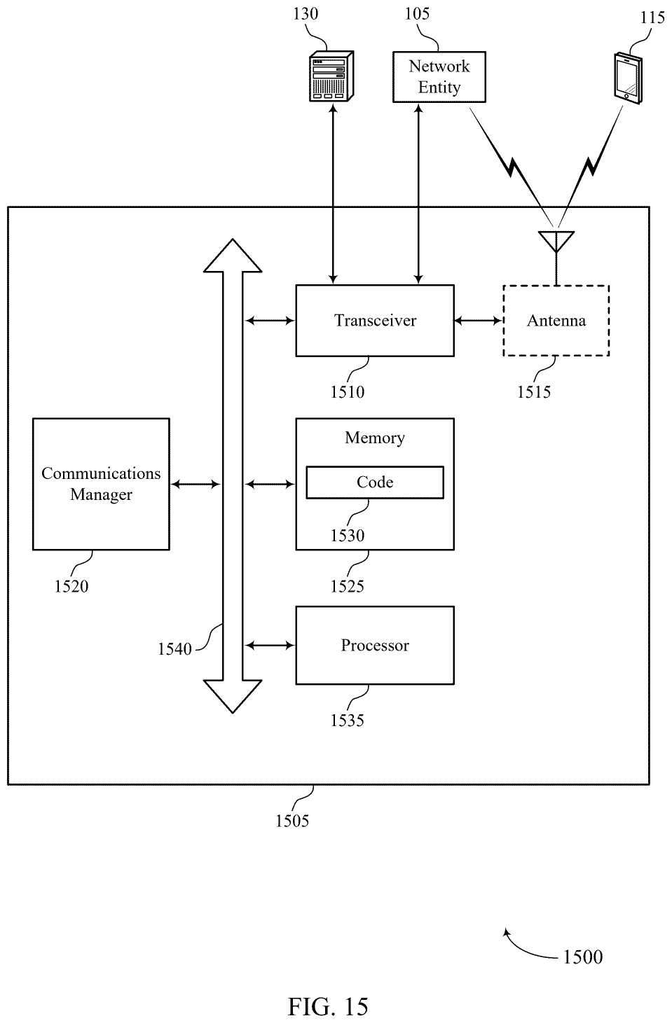

FIG. 15 shows a diagram of a system 1500 including a device 1505 that supports machine learning-enabled mobility for wireless communications in accordance with one or more examples as disclosed herein. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting machine learning-enabled mobility for wireless communications). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

Additionally, or alternatively, the communications manager 1520 may support wireless communications in accordance with examples as disclosed herein. For example, the communications manager 1520 is capable of, configured to, or operable to support a means for transmitting first reference signaling from a first cell. The communications manager 1520 is capable of, configured to, or operable to support a means for performing a handover procedure to the first cell in accordance with a set of one or more values of a set of one or more parameters associated with the handover procedure, where the set of one or more values is selected based on a machine learning model and the first reference signaling.

By including or configuring the communications manager 1520 in accordance with examples as described herein, the device 1505 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of machine learning-enabled mobility for wireless communications as described herein, or the at least one processor 1535 and the at least one memory 1525 may be otherwise configured to, individually or collectively, perform or support such operations.

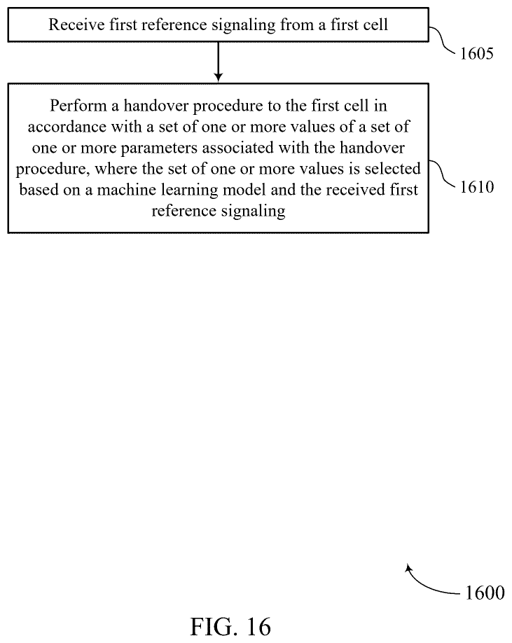

FIG. 16 shows a flowchart illustrating a method 1600 that supports machine learning-enabled mobility for wireless communications in accordance with one or more examples as disclosed herein. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving first reference signaling from a first cell. The operations of 1605 may be performed in accordance with examples as disclosed herein. In some examples, aspects of the operations of 1605 may be performed by a reference signaling component 1025 as described with reference to FIG. 10.

At 1610, the method may include performing a handover procedure to the first cell in accordance with a set of one or more values of a set of one or more parameters associated with the handover procedure, where the set of one or more values is selected based on a machine learning model and the received first reference signaling. The operations of 1610 may be performed in accordance with examples as disclosed herein. In some examples, aspects of the operations of 1610 may be performed by a handover procedure component 1030 as described with reference to FIG. 10.

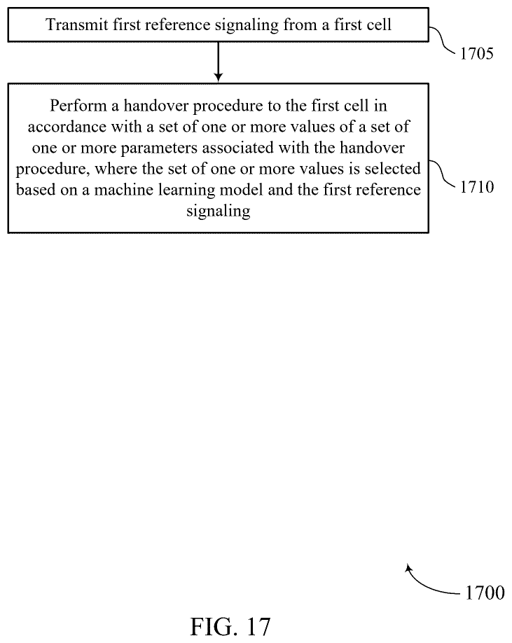

FIG. 17 shows a flowchart illustrating a method 1700 that supports machine learning-enabled mobility for wireless communications in accordance with one or more examples as disclosed herein. The operations of the method 1700 may be implemented by a network entity or its components as described herein. For example, the operations of the method 1700 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1705, the method may include transmitting first reference signaling from a first cell. The operations of 1705 may be performed in accordance with examples as disclosed herein. In some examples, aspects of the operations of 1705 may be performed by a reference signaling component 1425 as described with reference to FIG. 14.

At 1710, the method may include performing a handover procedure to the first cell in accordance with a set of one or more values of a set of one or more parameters associated with the handover procedure, where the set of one or more values is selected based on a machine learning model and the first reference signaling. The operations of 1710 may be performed in accordance with examples as disclosed herein. In some examples, aspects of the operations of 1710 may be performed by a handover procedure component 1430 as described with reference to FIG. 14.

The following provides an overview of aspects of the present disclosure:

Aspect 1: A method for wireless communications at a UE, comprising: receiving first reference signaling from a first cell; and performing a handover procedure to the first cell in accordance with a set of one or more values of a set of one or more parameters associated with the handover procedure, wherein the set of one or more values is selected based at least in part on a machine learning model and the received first reference signaling.

Aspect 2: The method of aspect 1, further comprising: receiving second reference signaling from a second cell comprising a serving cell of the UE, wherein the handover procedure to the first cell is performed based at least in part on the received second reference signaling.

Aspect 3: The method of aspect 2, further comprising: determining a first threshold value based at least in part on a first measurement of the received first reference signaling, wherein the first measurement comprises at least one of a first actual measurement or a first predicted measurement; determining a second threshold value based at least in part on a second measurement of the received second reference signaling, wherein the second measurement comprises at least one of a second actual measurement or a second predicted measurement; and determining a third threshold value based at least in part on a difference between the first measurement and the second measurement; wherein the handover procedure is performed based at least in part on the first threshold value, the second threshold value, or the third threshold value, or any combination thereof.

Aspect 4: The method of any of aspects 1 through 3, further comprising: receiving a configuration that indicates a plurality of candidate values for each of one or more parameters of the set of one or more parameters associated with the handover procedure, wherein the set of one or more values is selected from the plurality of candidate values.

Aspect 5: The method of any of aspects 1 through 4, further comprising: transmitting a request message to modify at least one value or a range of values of at least one parameter of the set of one or more parameters associated with the handover procedure; and receiving a response message that indicates an acknowledgement of the modified at least one value or the modified range of values of the at least one parameter in response to the transmitted request message.

Aspect 6: The method of any of aspects 1 through 5, wherein the handover procedure is performed based at least in part on a set of one or more conditions, and wherein the set of one or more conditions comprise a RLF, a threshold duration for the handover procedure, a link quality associated with the first cell, or any combination thereof.

Aspect 7: The method of any of aspects 1 through 6, wherein an output of the machine learning model comprises a predicted set of one or more values of the set of one or more parameters associated with the handover procedure, the method further comprising: determining whether the predicted set of one or more values satisfies a set of one or more conditions, wherein the handover procedure is performed based at least in part on the set of one or more conditions being satisfied by the predicted set of one or more values.

Aspect 8: The method of aspect 7, wherein at least one condition of the set of one or more conditions comprises a throughput during a duration associated with the handover procedure.

Aspect 9: The method of any of aspects 1 through 8, wherein the set of one or more parameters comprises a value associated with a time window, and wherein the time window corresponds to a first time instance associated with at least one condition of a set of one or more conditions being satisfied and a second time instance associated with a beginning of the handover procedure.

Aspect 10: The method of any of aspects 1 through 9, further comprising: transmitting an indication of the set of one or more values of the set of one or more parameters associated with the handover procedure.

Aspect 11: The method of any of aspects 1 through 10, further comprising: determining the set of one or more values of the set of one or more parameters associated with the handover procedure based at least in part on the machine learning model; and transmitting a report indicating at least one of the set of one or more values of the set of one or more parameters associated with the handover procedure, or one or more metrics associated with the determined set of one or more values.

Aspect 12: The method of any of aspects 1 through 11, further comprising: transmitting a report indicating at least one of a first measurement of the received first reference signaling from the first cell or a first measurement prediction, or a second measurement of received second reference signaling from a second cell comprising a serving cell of the UE or a second measurement prediction; wherein the handover procedure is performed based at least in part on whether a handover command is received within a threshold duration after the transmitted report.

Aspect 13: The method of aspect 12, further comprising: estimating a delay time between the transmitted report and reception of the handover command, wherein the set of one or more values is based at least in part on the estimated delay time.

Aspect 14: The method of any of aspects 1 through 13, wherein the handover procedure comprises a cell change procedure, and wherein the cell change procedure comprises a conditional PSCell addition procedure, a measurement report-based PSCell addition procedure, a subsequent PSCell conditional addition procedure, a conditional PSCell change procedure, a measurement report-based PSCell change procedure, or a subsequent PSCell conditional change procedure.

Aspect 15: A method for wireless communications at a network entity, comprising: transmitting first reference signaling from a first cell; and performing a handover procedure to the first cell in accordance with a set of one or more values of a set of one or more parameters associated with the handover procedure, wherein the set of one or more values is selected based at least in part on a machine learning model and the received first reference signaling.

Aspect 16: The method of aspect 15, further comprising: transmitting a configuration that indicates a plurality of candidate values for each of one or more parameters of the set of one or more parameters associated with the handover procedure, wherein the set of one or more values is selected from the plurality of candidate values.

Aspect 17: The method of any of aspects 15 through 16, further comprising: receiving a request message to modify at least one value or a range of values of at least one parameter of the set of one or more parameters associated with the handover procedure; and transmitting a response message that indicates an acknowledgement of the modified at least one value or the modified range of values of the at least one parameter in response to the received request message.

Aspect 18: The method of any of aspects 15 through 17, wherein the handover procedure is performed based at least in part on a set of one or more conditions, and wherein the set of one or more conditions comprise a RLF, a threshold duration for the handover procedure, a link quality associated with the first cell, or any combination thereof.

Aspect 19: The method of any of aspects 15 through 18, wherein an output of the machine learning model comprises a predicted set of one or more values of the set of one or more parameters associated with the handover procedure, the method further comprising: determining whether the predicted set of one or more values satisfies a set of one or more conditions, wherein the handover procedure is performed based at least in part on the set of one or more conditions being satisfied by the predicted set of one or more values.

Aspect 20: The method of aspect 19, wherein at least one condition of the set of one or more conditions comprises a throughput during a duration associated with the handover procedure.

Aspect 21: The method of any of aspects 15 through 20, wherein the set of one or more parameters comprises a value associated with a time window, and wherein the time window corresponds to a first time instance associated with at least one condition of a set of one or more conditions being satisfied and a second time instance associated with a beginning of the handover procedure.

Aspect 22: The method of any of aspects 15 through 21, further comprising: receiving an indication of the set of one or more values of the set of one or more parameters associated with the handover procedure.

Aspect 23: The method of any of aspects 15 through 22, further comprising: receiving a report indicating at least one of the set of one or more values of the set of one or more parameters associated with the handover procedure, or one or more metrics associated with the determined set of one or more values, wherein the set of one or more values of the set of one or more parameters associated with the handover procedure is determined based at least in part on the machine learning model.

Aspect 24: The method of any of aspects 15 through 23, further comprising: receiving a report indicating at least one of a first measurement of the first reference signaling from the first cell or a first measurement prediction, or a second measurement of second reference signaling from a second cell comprising a serving cell of the UE or a second measurement prediction; wherein the handover procedure is performed based at least in part on whether a handover command is transmitted within a threshold duration after the received report.

Aspect 25: The method of any of aspects 15 through 24, wherein the handover procedure comprises a cell change procedure, and wherein the cell change procedure comprises a conditional PSCell addition procedure, a measurement report-based PSCell addition procedure, a subsequent PSCell conditional addition procedure, a conditional PSCell change procedure, a measurement report-based PSCell change procedure, or a subsequent PSCell conditional change procedure.

Aspect 26: A UE for wireless communications, comprising one or more memories storing processor-executable code, and one or more processors coupled with the one or more memories and individually or collectively operable to execute the code to cause the UE to perform a method of any of aspects 1 through 14.

Aspect 27: A UE for wireless communications, comprising at least one means for performing a method of any of aspects 1 through 14.

Aspect 28: A non-transitory computer-readable medium storing code for wireless communications, the code comprising instructions executable by one or more processors to perform a method of any of aspects 1 through 14.

Aspect 29: A network entity for wireless communications, comprising one or more memories storing processor-executable code, and one or more processors coupled with the one or more memories and individually or collectively operable to execute the code to cause the network entity to perform a method of any of aspects 15 through 25.

Aspect 30: A network entity for wireless communications, comprising at least one means for performing a method of any of aspects 15 through 25.

Aspect 31: A non-transitory computer-readable medium storing code for wireless communications, the code comprising instructions executable by one or more processors to perform a method of any of aspects 15 through 25.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first reference signaling from a first cell; and
perform a handover procedure to the first cell in accordance with a set of one or more values of a set of one or more parameters associated with the handover procedure, wherein the set of one or more values is selected based at least in part on a machine learning model and the received first reference signaling.

2. The UE of claim 1, wherein the one or more processors are individually or collectively further operable to execute the code to cause the UE to:
receive second reference signaling from a second cell comprising a serving cell of the UE,
wherein the handover procedure to the first cell is performed based at least in part on the received second reference signaling.

3. The UE of claim 2, wherein the one or more processors are individually or collectively further operable to execute the code to cause the UE to:
determine a first threshold value based at least in part on a first measurement of the received first reference signaling, wherein the first measurement comprises at least one of a first actual measurement or a first predicted measurement;
determine a second threshold value based at least in part on a second measurement of the received second reference signaling, wherein the second measurement comprises at least one of a second actual measurement or a second predicted measurement; and
determine a third threshold value based at least in part on a difference between the first measurement and the second measurement,
wherein the handover procedure is performed based at least in part on the first threshold value, the second threshold value, or the third threshold value, or any combination thereof.

4. The UE of claim 1, wherein the one or more processors are individually or collectively further operable to execute the code to cause the UE to:
receive a configuration that indicates a plurality of candidate values for each of one or more parameters of the set of one or more parameters associated with the handover procedure,
wherein the set of one or more values is selected from the plurality of candidate values.

5. The UE of claim 1, wherein the one or more processors are individually or collectively further operable to execute the code to cause the UE to:
transmit a request message to modify at least one value or a range of values of at least one parameter of the set of one or more parameters associated with the handover procedure; and
receive a response message that indicates an acknowledgement of the modified at least one value or the modified range of values of the at least one parameter in response to the transmitted request message.

6. The UE of claim 1, wherein the handover procedure is performed based at least in part on a set of one or more conditions, and wherein the set of one or more conditions comprise a radio link failure (RLF), a threshold duration for the handover procedure, a link quality associated with the first cell, or any combination thereof.

7. The UE of claim 1, wherein an output of the machine learning model comprises a predicted set of one or more values of the set of one or more parameters associated with the handover procedure, and the one or more processors are individually or collectively further operable to execute the code to cause the UE to:
determine whether the predicted set of one or more values satisfies a set of one or more conditions,
wherein the handover procedure is performed based at least in part on the set of one or more conditions being satisfied by the predicted set of one or more values.

8. The UE of claim 7, wherein at least one condition of the set of one or more conditions comprises a throughput during a duration associated with the handover procedure.

9. The UE of claim 1, wherein the set of one or more parameters comprises a value associated with a time window, and wherein the time window corresponds to a first time instance associated with at least one condition of a set of one or more conditions being satisfied and a second time instance associated with a beginning of the handover procedure.

10. The UE of claim 1, wherein the one or more processors are individually or collectively further operable to execute the code to cause the UE to:
transmit an indication of the set of one or more values of the set of one or more parameters associated with the handover procedure.

11. The UE of claim 1, wherein the one or more processors are individually or collectively further operable to execute the code to cause the UE to:
determine the set of one or more values of the set of one or more parameters associated with the handover procedure based at least in part on the machine learning model; and
transmit a report indicating at least one of the set of one or more values of the set of one or more parameters associated with the handover procedure, or one or more metrics associated with the determined set of one or more values.

12. The UE of claim 1, wherein the one or more processors are individually or collectively further operable to execute the code to cause the UE to:
transmit a report indicating at least one of a first measurement of the received first reference signaling from the first cell or a first measurement prediction, or a second measurement of received second reference signaling from a second cell comprising a serving cell of the UE or a second measurement prediction;
wherein the handover procedure is performed based at least in part on whether a handover command is received within a threshold duration after the transmitted report.

13. The UE of claim 12, wherein the one or more processors are individually or collectively further operable to execute the code to cause the UE to:
estimate a delay time between the transmitted report and reception of the handover command, wherein the set of one or more values is based at least in part on the estimated delay time.

14. The UE of claim 1, wherein the handover procedure comprises a cell change procedure, and wherein the cell change procedure comprises a conditional primary special cell (PSCell) addition procedure, a measurement report-based PSCell addition procedure, a subsequent PSCell conditional addition procedure, a conditional PSCell change procedure, a measurement report-based PSCell change procedure, or a subsequent PSCell conditional change procedure.

15. A network entity, comprising:
one or more memories storing processor-executable code; and
one or more processors coupled with the one or more memories and individually or collectively operable to execute the code to cause the network entity to:
transmit first reference signaling from a first cell; and
perform a handover procedure to the first cell in accordance with a set of one or more values of a set of one or more parameters associated with the handover procedure, wherein the set of one or more values is selected based at least in part on a machine learning model and the first reference signaling.

16. The network entity of claim 15, wherein the one or more processors are individually or collectively further operable to execute the code to cause the network entity to:
transmit a configuration that indicates a plurality of candidate values for each of one or more parameters of the set of one or more parameters associated with the handover procedure,
wherein the set of one or more values is selected from the plurality of candidate values.

17. The network entity of claim 15, wherein the one or more processors are individually or collectively further operable to execute the code to cause the network entity to:
receive a request message to modify at least one value or a range of values of at least one parameter of the set of one or more parameters associated with the handover procedure; and
transmit a response message that indicates an acknowledgement of the modified at least one value or the modified range of values of the at least one parameter in response to the received request message.

18. The network entity of claim 15, wherein the handover procedure is performed based at least in part on a set of one or more conditions, and wherein the set of one or more conditions comprise a radio link failure (RLF), a threshold duration for the handover procedure, a link quality associated with the first cell, or any combination thereof.

19. The network entity of claim 15, wherein an output of the machine learning model comprises a predicted set of one or more values of the set of one or more parameters associated with the handover procedure, and the one or more processors are individually or collectively further operable to execute the code to cause the network entity to:
determine whether the predicted set of one or more values satisfies a set of one or more conditions, wherein the handover procedure is performed based at least in part on the set of one or more conditions being satisfied by the predicted set of one or more values.

20. The network entity of claim 19, wherein at least one condition of the set of one or more conditions comprises a throughput during a duration associated with the handover procedure.

21. The network entity of claim 15, wherein the set of one or more parameters comprises a value associated with a time window, and wherein the time window corresponds to a first time instance associated with at least one condition of a set of one or more conditions being satisfied and a second time instance associated with a beginning of the handover procedure.

22. The network entity of claim 15, wherein the one or more processors are individually or collectively further operable to execute the code to cause the network entity to:
receive an indication of the set of one or more values of the set of one or more parameters associated with the handover procedure.

23. The network entity of claim 15, wherein the one or more processors are individually or collectively further operable to execute the code to cause the network entity to:
receive a report indicating at least one of the set of one or more values of the set of one or more parameters associated with the handover procedure, or one or more metrics associated with the set of one or more values,
wherein the set of one or more values of the set of one or more parameters associated with the handover procedure is determined based at least in part on the machine learning model.

24. The network entity of claim 15, wherein the one or more processors are individually or collectively further operable to execute the code to cause the network entity to:
receive a report indicating at least one of a first measurement of the first reference signaling from the first cell or a first measurement prediction, or a second measurement of received second reference signaling from a second cell comprising a serving cell of a user equipment (UE) or a second measurement prediction;
wherein the handover procedure is performed based at least in part on whether a handover command is transmitted within a threshold duration after the received report.

25. The network entity of claim 15, wherein the handover procedure comprises a cell change procedure, and wherein the cell change procedure comprises a conditional primary secondary cell (PSCell) addition procedure, a measurement report-based PSCell addition procedure, a subsequent PSCell conditional addition procedure, a conditional PSCell change procedure, a measurement report-based PSCell change procedure, or a subsequent PSCell conditional change procedure.

26. A method for wireless communications at a user equipment (UE), comprising:
receiving first reference signaling from a first cell; and
performing a handover procedure to the first cell in accordance with a set of one or more values of a set of one or more parameters associated with the handover procedure, wherein the set of one or more values is selected based at least in part on a machine learning model and the received first reference signaling.

27. The method of claim 26, further comprising:
receiving second reference signaling from a second cell comprising a serving cell of the UE,
wherein the handover procedure to the first cell is performed based at least in part on the received second reference signaling.

28. The method of claim 27, further comprising:
determining a first threshold value based at least in part on a first measurement of the received first reference signaling, wherein the first measurement comprises at least one of a first actual measurement or a first predicted measurement;
determining a second threshold value based at least in part on a second measurement of the received second reference signaling, wherein the second measurement comprises at least one of a second actual measurement or a second predicted measurement; and
determining a third threshold value based at least in part on a difference between the first measurement and the second measurement,
wherein the handover procedure is performed based at least in part on the first threshold value, the second threshold value, or the third threshold value, or any combination thereof.

29. The method of claim 26, further comprising:
receiving a configuration that indicates a plurality of candidate values for each of one or more parameters of the set of one or more parameters associated with the handover procedure, wherein the set of one or more values is selected from the plurality of candidate values.

30. A method for wireless communications at a network entity, comprising:
transmitting first reference signaling from a first cell; and
performing a handover procedure to the first cell in accordance with a set of one or more values of a set of one or more parameters associated with the handover procedure, wherein the set of one or more values is selected based at least in part on a machine learning model and the first reference signaling.
